(19) United States
(12) Patent Application Publication
(10) Pub. No.: US 2025/0233283 A1
(43) Pub. Date: Jul. 17, 2025

(54) FLEXIBLE BATTERY

(71) Applicant: MAXELL, LTD., Otokuni-gun (JP)

(72) Inventors: Hiroyoshi Aoki, Otokuni-gun (JP); Seiji Ishizawa, Otokuni-gun (JP); Hideaki Katayama, Otokuni-gun (JP); Haruki Kamizori, Otokuni-gun (JP)

(73) Assignee: MAXELL, LTD., Otokuni-gun (JP)

(21) Appl. No.: 19/094,091

(22) Filed: Mar. 28, 2025

Related U.S. Application Data
(63) Continuation of application No. PCT/JP2023/033514, filed on Sep. 14, 2023.

(30) Foreign Application Priority Data
Sep. 28, 2022 (JP) 2022-154397

(51) Int. Cl. H01M 50/531; H01M 4/66; H01M 4/80; H01M 10/0525; H01M 10/0562; H01M 50/105; H01M 50/586

(52) U.S. Cl. CPC H01M 50/531; H01M 4/661; H01M 4/80; H01M 10/0525; H01M 10/0562; H01M 50/105; H01M 50/586

(57) ABSTRACT

The flexible battery comprising multiple power generation elements. Each of the power generation elements comprises a positive electrode, a negative electrode, and a solid electrolyte layer arranged between the positive and negative electrodes. The positive electrode comprises a positive electrode composition layer and a conductive substrate in a form of a sheet arranged on the surface of the positive electrode composition layer. The negative electrode comprises a negative electrode composition layer and a conductive substrate in a form of a sheet arranged on the surface of the negative electrode composition layer. The multiple power generation elements are arranged on a flexible substrate. Each positive electrode is directly connected to a current collector, thereby connecting the positive electrodes to each other via the current collector. Each negative electrode is directly connected to a current collector, thereby directly connecting the negative electrodes to each other via the current collector.

### CROSS-REFERENCE TO RELATED APPLICATIONS

This application is a continuation of PCT/JP2023/033514 filed on Sep. 14, 2023, which is based upon and claims the benefit of priority from the prior Japanese Patent Application No. 2022-154397 filed on Sep. 28, 2022, the entire contents of which are incorporated herein by reference.

### TECHNICAL FIELD

The present invention relates to a flexible battery in which internal resistance is reduced.

### TECHNICAL BACKGROUND

In recent years, with the development of portable electronic devices such as mobile phones and notebook personal computers, as well as with the practical application of electric vehicles, there has been a growing need for batteries that are compact, lightweight, high-capacity and high-energy-density.

Currently, in lithium batteries that can meet this requirement, especially lithium ion batteries, lithium-containing composite oxides such as lithium cobalt oxide (LiCoO₂) and lithium nickel oxide (LiNiO₂) are used as the positive electrode active material, graphite or the like is used as the negative electrode active material, an organic electrolyte solution containing an organic solvent and a lithium salt is used as the non-aqueous electrolyte.

With the further development of lithium-ion battery application equipment, there is a demand for further extension of the life of lithium-ion batteries, higher capacity, and higher energy density, and the reliability of lithium-ion batteries with longer life, higher capacity, and higher energy density.

However, the organic electrolyte used in the lithium-ion battery contains an organic solvent that is a flammable substance, and therefore there is a possibility that the organic electrolyte generates abnormal heat when it comes to an abnormal situation such as a short circuit in the battery. In addition, with the recent increase in the energy density of lithium-ion batteries and the increasing trend of the amount of organic solvents in organic electrolytes, a need of the reliability of lithium-ion batteries has become even more.

In such situations, all-solid-state lithium batteries (all-solid-state batteries) that do not use organic solvents are also being considered. All-solid-state lithium batteries use a molded body of solid electrolyte instead of conventional organic solvent-based electrolytes, therefore eliminating the risk of abnormal heating of the solid electrolyte and providing high reliability.

In addition, all-solid-state batteries are not only highly safe, but also highly reliable, highly environmentally resistant, and have a long life, so they are expected to be maintenance-free batteries that can contribute to the development of society while continue to contribute to safety and security. Of the seventeen Sustainable Development Goals (SDGs) established by the United Nations, the provision of all-solid-state batteries to the society can contribute to the achievement of Goal 3 (Ensure healthy lives and promote well-being for all at all ages), Goal 7 (Ensure access to affordable, reliable, sustainable and modern energy for all), Goal 11 (Make cities and human settlements inclusive, safe, resilient and sustainable) and Goal 12 (Ensure sustainable consumption and production patterns).

By the way, the spread of wearable devices in recent years has diversified display devices and energy storage devices; and flexible batteries in sheet or film form are required in technical fields such as thin-film displays, flexible light emitters formed of thin films such as organic field emitting devices (OLEDs), and power storage functions in sheet-shaped solar cells.

As a battery capable of responding to such a request, Patent Document 1 discloses a flexible thin battery in which a plurality of batteries with a thickness of 1 mm or less are arranged on a flexible substrate such that the positive electrodes and negative electrodes of the plurality of batteries, respectively, are connected by wiring.

Patent Document 2 discloses a bendable battery module in which a plurality of all-solid-state batteries are connected by wiring on a bendable substrate.

However, in the technology disclosed in Patent Documents 1 and 2, there is an issue that the energy density is reduced because each unit battery disposed on the substrate (substrate board) has an exterior member (package), and the occupied volume of the components not involved in power generation in the entire battery is increased.

On the other hand, Patent Document 3 discloses a sheet-shaped battery in which a plurality of solid-state power generation cells, each of which is comprised of a power generation element in which a positive electrode active material, a solid electrolyte, and a negative electrode active material are stacked in layers, are disposed in a grid pattern on a sheet having a bendability and a current collection function. That is, since the technology disclosed in Patent Document 3 does not require individual solid power generation cell to be packaged, it can be said that it is effective in increasing the energy density of the entire battery.

### RELATED ART REFERENCES

### Patent References

Patent Reference No. 1: Japanese Laid-Open Patent Publication No. 2015-15143
Patent Reference No. 2: International Patent Publication No. 2016-092888
Patent Reference No. 3: Japanese Laid-Open Patent Publication No. 2000-195482

### SUMMARY OF THE INVENTION

### The objectives to Solve by the Invention

However, as disclosed in Patent Document 3, when the electrode active material layer and the current collector sheet are directly contacted, there is a problem that it is difficult to sufficiently reduce the internal resistance of the battery because the contact resistance is large. The present invention has been made in view of the preceding article, and an object thereof is to provide a flexible battery in which the internal resistance of the battery is reduced.

### Means to Solve the Objectives

The flexible battery comprising multiple power generation elements sealed within an exterior body, wherein each of the power generation elements comprises a positive electrode, a negative electrode, and a solid electrolyte layer arranged between the positive and negative electrodes; wherein the positive electrode comprises a positive electrode composition layer and a conductive substrate in a form of a sheet arranged on the surface of the positive electrode composition layer; wherein the negative electrode comprises a negative electrode composition layer and a conductive substrate in a form of a sheet arranged on the surface of the negative electrode composition layer; wherein the multiple power generation elements are arranged on a flexible substrate, and each positive electrode is directly connected to a current collector, thereby connecting the positive electrodes to each other via the current collector, and each negative electrode is directly connected to a current collector, thereby directly connecting the negative electrodes to each other via the current collector; and wherein each of the current collector connecting the positive electrodes to each other and the current collector connecting the negative electrodes to each other is connected to external connection terminals.

### Effects of the Invention

The present invention can provide a flexible battery in which internal resistance is reduced.

### BRIEF DESCRIPTION OF THE DRAWINGS

FIG. 1 It is a cross-sectional view schematically illustrating an example of the flexible battery of the present invention.

FIG. 2 It is a cross-sectional view schematically illustrating yet another example of the flexible battery of the present invention.

FIG. 3 It is a cross-sectional view schematically illustrating yet another example of the flexible battery of the present invention.

FIG. 4 It is a cross-sectional view schematically illustrating the state in which the flexible battery of FIG. 3 is bent.

FIG. 5 It is an image of a scanning electron microscope of the surface (surface of the positive electrode) in an example of a power generation element.

FIG. 6 It is a perspective view schematically illustrating an example of the flexible battery of the present invention.

FIG. 7 It is a cross-sectional view schematically illustrating yet another example of the flexible battery of the present invention.

FIG. 8 It is a cross-sectional view schematically illustrating yet another example of the flexible battery of the present invention.

FIG. 9 It is a cross-sectional view schematically illustrating yet another example of the flexible battery of the present invention.

FIG. 10 It is a cross-sectional view schematically illustrating yet another example of the flexible battery of the present invention.

### EMBODIMENTS TO CARRY OUT THE INVENTION

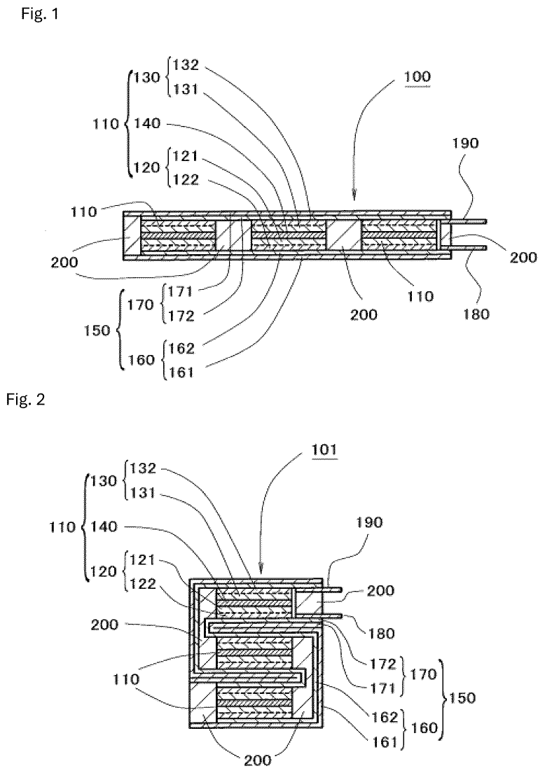

FIG. 1 shows a schematic cross-sectional view of an example of the flexible battery of the present invention. The flexible battery 100 shown in FIG. 1 is configured by encapsulating three power generation elements 110 in the exterior body 150. The power generation element 110 includes a positive electrode 120, a negative electrode 130, and a solid electrolyte layer 140 interposed therebetween.

In the flexible battery 100 shown in FIG. 1, the exterior body 150 is composed of a flexible substrate (hereinafter simply referred to as “substrate”) 160 and 170. Three power generation elements 110 are arranged on the substrates 160 and 170.

The substrate 160 has an insulating layer 161 and a conductive layer 162, and the conductive layer 162 functions as a current collector at a side of the positive electrode. That is, each positive electrode 120 of the three power generation elements 110 is in direct contact with the conductive layer 162 of the substrate 160, and therefore, the positive electrodes 120 of the three power generation elements 110 are directly connected by the conductive layer 162, that is a current collector. Further, a connection terminal 180 for connecting the positive electrode of the flexible battery 100 and an external device is connected to the conductive layer 162.

Further, the substrate 170 has an insulating layer 171 and a conductive layer 172, and the conductive layer 172 functions as a current collector at the side of the negative electrode. That is, each negative electrode 130 of the three power generation elements 110 is in direct contact with the conductive layer 172 of the substrate 170, and therefore, the negative electrodes 130 of the three power generation elements 110 are directly connected by the conductive layer 172, that is a current collector. Further, a connection terminal 190 for connecting the negative electrode of the flexible battery 100 and an external device is connected to the conductive layer 172.

In the flexible battery of the present invention, as shown in FIG. 1, there are a multiple power generation elements, and these power generation elements are arranged on a flexible substrate without being individually packaged, which are sealed in the exterior body, in such a condition where by directly connecting the positive electrode of each power generation element to a current collector (a current collector for connecting positive electrodes to each other), all positive electrodes are connected by the current collector; and in such a condition where by directly connecting the negative electrode of each power generation element to the current collector (current collector for connecting negative electrodes), all negative electrodes are connected by the current collector. Therefore, in the flexible battery of the present invention, the volume ratio of the exterior body to the whole can be reduced compared to a battery configured by individually packaging each of the power generation element (unit battery), thereby increasing the energy density.

Also in the flexible battery 100 shown in FIG. 1, the positive electrode 120 has a positive electrode composition layer 121 and a porous metal substrate 122 that is a conductive substrate, such that the entire porous metal substrate 122, including the end at the side of the positive electrode composition layer 121 is embedded in the surface part of the positive electrode composition layer 121. That is, the entire location where the porous metal substrate 122 is present corresponds to a region in which the positive electrode composition layer and the porous metal substrate coexist. Furthermore, in the positive electrode 120, the end opposite to the side of the positive electrode composition layer 121 of the porous metal substrate 122 (the lower end of FIG. 1) is exposed. The dotted line in the positive electrode 120 indicates the boundary between the region in which the porous metal substrate does not coexist in the positive electrode composition layer 121 and the region where the positive electrode composition layer and the porous metal substrate coexist. This corresponds to the end of the porous metal substrate 122 at the side of the positive electrode composition layer 121.

Furthermore, in the flexible battery 100 shown in FIG. 1, the negative electrode 130 has a negative electrode composition layer 131 and a porous metal substrate 132 that is a conductive substrate. The entire of the porous metal substrate 132, including the end at the side of the negative electrode composition layer 131, is embedded in the surface part of the negative electrode composition layer 131. That is, the entire of the location where the porous metal substrate 132 exists corresponds to an area in which the negative electrode composition layer and the porous metal substrate coexist. Furthermore, in the negative electrode 130, the end of the porous metal substrate 132 which is opposite to the side of the negative electrode composition layer 131 (the upper end of FIG. 1) is exposed. The dotted line in the negative electrode 130 indicates the boundary between the region in which the porous metal substrate does not coexist in the negative electrode composition layer 131 and the region where the negative electrode composition layer and the porous metal substrate coexist. This corresponds to the end of the porous metal substrate 132 at the side of the negative electrode composition layer 131.

In the flexible battery, as shown in FIG. 1, the positive electrode has a positive electrode composition layer and a conductive substrate in a form of a sheet disposed on the surface of the positive electrode composition layer. Further, the negative electrode has a negative electrode composition layer and a conductive substrate in a form of a sheet disposed on the surface of the negative electrode composition layer.

In a battery (battery module) that has multiple power generation elements (unit cells), regarding the electrical connection between each power generation element, the following can be found. Compared with the method to connect each other as disclosed in Patent Documents 1 and 2 in which for example, individual power generation elements are packaged in an exterior body with the connection terminals of the positive and negative electrodes exposed to the outside, the method as disclosed in Patent Document 3 in which a direct connection of the electrodes of each power generation element with a collector tends to become unstable in the electrical connections between the positive electrodes and between the negative electrodes.

However, when the positive electrode related to the power generation element has a positive electrode composition layer and a conductive substrate in a form of a sheet arranged on the surface of the positive electrode composition layer, it is possible to achieve good electrical connections between the conductive substrate in a form of a sheet functioning as a current collector of the positive electrode within the power generation element and the positive electrode composition layer, as well as between the conductive substrate in a form of a sheet and the current collector connecting the positive electrodes. Additionally, when the negative electrode related to the power generation element has a negative electrode composition layer and a conductive substrate in a form of a sheet arranged on the surface of the negative electrode composition layer, it is possible to achieve good electrical connections between the conductive substrate in a form of a sheet functioning as the current collector of the negative electrode within the power generation element and the negative electrode composition layer, as well as between the conductive substrate in a form of a sheet and the current collector connecting the negative electrodes. Therefore, it is possible to ensure good electrical connections between the power generation elements without individually packaging each power generation element, thereby resulting a flexible battery having higher reliability of electrical connections and lower internal resistance.

In particular, it is preferable to have the following configurations in the flexible battery, as shown in FIG. 1; the positive electrode has a sheet-like porous metal substrate as the conductive substrate; at least a part of the porous metal substrate of the positive electrode, including the end portion at the side of the positive electrode composition layer, is embedded in the surface part of the positive electrode composition layer and integrated with it; the other end of the porous metal substrate of the positive electrode is exposed on the surface of the positive electrode; additionally, the negative electrode has a sheet-like porous metal substrate as the conductive substrate; at least a part of the porous metal substrate of the negative electrode, including the end portion at the side of the negative electrode composition layer, is embedded in the surface part of the negative electrode composition layer and integrated with it; the other end of the porous metal substrate of the negative electrode is exposed on the surface of the negative electrode. In this case, the electrical connections between the sheet-like porous metal substrate functioning as a positive electrode current collector in the power generation element and the positive electrode composition layer, and between the sheet-like porous metal substrate and the current collector connecting the positive electrodes can be further improved. In addition, the electrical connections between the sheet-like porous metal substrate functioning as a negative electrode current collector in the power generation element and the negative electrode composition layer, and between the sheet-like porous metal substrate and the current collector connecting the negative electrodes can be further improved. As a result, it is possible to further reduce the internal resistance of the flexible battery.

Further, in the flexible battery 100 shown in FIG. 1, the insulators 200 are disposed between the power generation elements 110, at the left side of the power generation element 110 arranged at the left end in the figure, and at the right side of the power generation element 110 arranged at the right end in the figure. As shown above, in the flexible battery, it is preferable that an insulator is disposed in at least a part of the region of the flexible substrate where the power generation elements are not disposed. Thereby, during the manufacture and use of the flexible battery, it is possible to suppress the misalignment of the power generation elements and the occurrence of a short circuit due to contact between the current collector on the positive electrode side and the current collector on the negative electrode side.

FIG. 2 shows a schematic cross-sectional view of another example of the flexible battery of the present invention. The flexible battery 101 shown in FIG. 2 has three power generation elements 110 and has a configuration in which it is folded at portions where these power generation elements 110 are not disposed of. By adjusting the form of the exterior body and the insulator disposed in the area where the power generation elements are not disposed, it is possible to fold the flexible battery of the present invention as shown in FIG. 2.

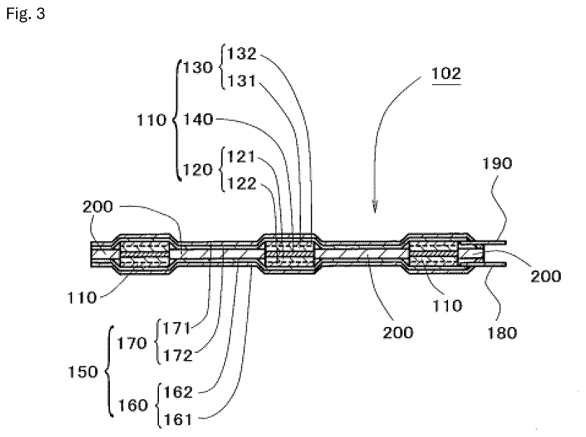

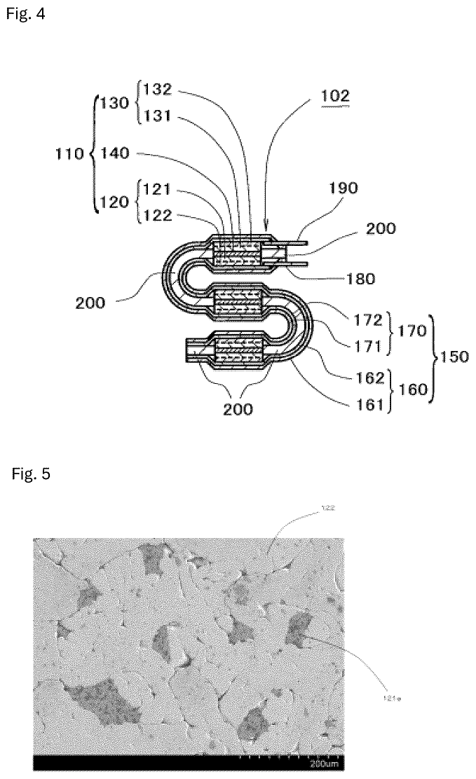

Further, each of FIGS. 3 and 4 shows a cross-sectional view schematically representing other examples of the flexible battery of the present invention. The flexible battery 102 shown in FIG. 3 has three power generation elements 110, and as with the flexible battery 100 shown in FIG. 1, the insulators 200 are disposed between the power generation elements 110, at the left side of the power generation element 110 arranged at the left end in the figure, and at the right side of the power generation element 110 arranged at the right end in the figure. In the flexible battery 102, the thickness of the portion at which the insulator 200 is placed (length in the vertical direction in the figure) is smaller than the thickness of the portion where the power generation element 110 is disposed. Therefore, as shown in FIG. 4, the flexible battery 102 is more easily bent at the place where the insulator 200 is disposed between the power generation elements 110 than the flexible battery 100 shown in FIG. 1.

The flexible battery of the present invention is flexible and deformable, for example, as shown in FIG. 2. The “flexible” used herein means that it is possible to bend 90 degrees or more by winding it around a core having an outer diameter of 3 mm, that even if charging and discharging is performed in a bent state, the discharge capacity when the discharge current is 0.2 C does not decrease by 3% or more compared to the state where it is not bent (In the flexible batteries in the Examples described later, it was confirmed that the characteristics described herein were satisfied).

Hereinafter, details of the flexible battery are described.

### Power Generation Element

The power generation element has a positive electrode, a negative electrode, and a solid electrolyte layer interposed between them.

### Positive Electrode

The positive electrode has a positive electrode composition layer containing a positive electrode active material, etc. and a sheet-like porous metal substrate that functions as a current collector.

When the flexible battery is a primary battery, the same positive electrode active material used in a conventionally known non-aqueous electrolyte primary battery can be used. Specifically, for example, manganese dioxide and lithium-containing manganese oxide [for example, LiMn₃O₆, and a composite oxide which has the same crystal structure (such as β type, γ type, or a structure in which β and γ types are mixed) as manganese dioxide in which the Li content is 3.5% by mass or less, preferably 2% by mass or less, more preferably 1.5% by mass or less, particularly preferably 1% by mass or less]; lithium-containing composite oxides, such as LiₐTi_{5/3}O₄ (4/3≤a<7/3); vanadium oxides; niobium oxides; titanium oxides; sulfides such as iron disulfide; graphite fluorides; silver sulfides such as Ag₂S; nickel oxides such as NiO₂; and the like.

When the flexible battery is a secondary battery, the same positive electrode active material used in a conventionally known non-aqueous electrolyte secondary battery can be used. Specifically, the examples can include a spinel-type lithium manganese composite oxide represented by Li₁₋ₓMᵣMn₂₋ᵣO₄ (where M is at least one element selected from the group consisting of Li, Na, K, B, Mg, Ca, Sr, Ba, Ti, V, Cr, Zr, Fe, Co, Ni, Cu, Zn, Al, Sn, Sb, In, Nb, Ta, Mo, W, Y, Ru, and Rh, and 0≤x≤1, 0≤r≤1); a layered compound represented by LiᵣMn₍₁₋ₛ₋ₜ₎Ni ₛM tO₍₂₋ᵤ₎Fᵥ (where M is at least one element selected from the group consisting of Co, Mg, Al, B, Ti, V, Cr, Fe, Cu, Zn, Zr, Mo, Sn, Ca, Sr, and W, and 0≤r≤1.2, 0<s<0.5, 0s≤0.5, u+v<1, −0.1≤u≤0.2, 0≤v≤0.1); lithium cobalt composite oxide represented by Li₁₋ₓCo₁₋ᵣMᵣO₂ (where M is at least one element selected from the group consisting of Al, Mg, Ti, V, Cr, Zr, Fe, Ni, Cu, Zn, Ga, Ge, Nb, Mo, Sn, Sb, and Ba, and 0≤x≤1, 0≤r≤0.5); lithium nickel composite oxide represented by Li₁₋ₓNi₁₋ᵣMᵣO₂ (where M is at least one element selected from the group consisting of Al, Mg, Ti, Zr, Fe, Co, Cu, Zn, Ga, Ge, Nb, Mo, Sn, Sb, and Ba, and 0≤x≤1, 0≤r≤0.5); olivine-type composite oxide represented by Li₁₋ₛ₋ₓM₁₋ᵣNᵣPO₄Fₛ (where M is at least one element selected from the group consisting of Fe, Mn, and Co, and Nis at least one element selected from the group consisting of Al, Mg, Ti, Zr, Ni, Cu, Zn, Ga, Ge, Nb, Mo, Sn, Sb, V, and Ba, and 0≤x≤1, 0≤r≤0.5, 0≤s≤1); and pyrophosphate compounds represented by Li₂₋ₓM₁₋ᵣNᵣP₂O₇ (where M is at least one element selected from the group consisting of Fe, Mn, and Co, and N is at least one element selected from the group consisting of Al, Mg, Ti, Zr, Ni, Cu, Zn, Ga, Ge, Nb, Mo, Sn, Sb, V, and Ba, and 0≤x≤2 and 0≤r≤0.5). Any one of these can be used alone or in combination with two or more.

When the flexible battery is a secondary battery, the average particle diameter of the positive electrode active material is preferably 1 μm or more, more preferably 2 μm or more, preferably 10 μm or less, and more preferably 8 μm or less. The positive electrode active material can be a primary particle or a secondary particle in which the primary particles are aggregated. When a positive electrode active material having an average particle diameter in the above range is used, the output characteristics of the battery are further improved because a large amount of the interface with the solid electrolyte contained in the positive electrode can be obtained.

The average particle diameter of the various particles (such as positive active material and solid electrolyte) as used herein means the 50% diameter value (D50) in the volume-based integrated fraction when the integral volume is determined from particles with a smaller particle size using a particle size distribution measurement device (such as a Microtrac particle size distribution measurement device “HRA9320” manufactured by Nikkiso Co., Ltd.).

When the flexible battery is a secondary battery, the positive electrode active material preferably has a reaction suppression layer on its surface for suppressing a reaction with a solid electrolyte contained in the positive electrode.

In the positive electrode composition layer, when the positive electrode active material comes into direct contact with the solid electrolyte, there is a risk that the solid electrolyte is oxidized to form a resistance layer, thereby leading to a decrease in ionic conductivity within the positive electrode composition layer. By providing a reaction suppression layer on the surface of the positive electrode active material to suppress reactions with the solid electrolyte and to prevent direct contact between the positive electrode active material and the solid electrolyte, it is possible to suppress the decrease in ionic conductivity within the positive electrode composite layer due to the oxidation of the solid electrolyte.

The reaction suppression layer can be made of a material that has ion conductivity and can suppress the reaction between the positive electrode active material and the solid electrolyte. The examples of the material that can constitute the reaction suppression layer can include an oxide containing Li and at least one element selected from the group consisting of Nb, P, B, Si, Ge, Ti and Zr, more specifically, Nb-containing oxides such as LiNbO₃, Li₃PO₄, Li₃BO₃, Li₄SiO₄, Li₄GeO₄, Li TiO₃, LiZrO₃, Li₂WO₄ and the like. The reaction suppression layer can contain only one of these oxides, or can contain two or more, and a plurality of these oxides can form a composite compound. Among these oxides, it is preferable to use Nb-containing oxides, and more preferably to use LiNbO₃.

The reaction suppression layer preferably exists on the surface at 0.1 to 1.0 parts by mass with respect to 100 parts by mass of the positive electrode active material. In this range, the reaction between the positive electrode active material and the solid electrolyte can be favorably suppressed.

The methods for forming a reaction suppression layer on the surface of the positive electrode active material include the sol-gel method, mechanofusion method, CVD method, PVD method, and ALD method.

The content of the positive electrode active material in the positive electrode composition is preferably 60 to 85% by mass from the viewpoint of increasing the energy density of the flexible battery.

The positive electrode composition can contain a conductive assistant. Specific examples thereof include carbon materials such as graphite (natural graphite and artificial graphite), graphene, carbon black, carbon nanofibers, and carbon nanotubes. Note that when Ag₂S, for example, is used as an active material, a conductive assistant does not necessarily be contained because Ag being conductive can be generated during the discharge reaction. When a conductive assistant is contained in the positive electrode composition, the content is preferably 1.0 parts by mass or more, preferably 7.0 parts by mass or less, and more preferably 6.5 parts by mass or less when the content of the positive electrode active material is 100 parts by mass.

The positive electrode composition can contain a binder. Specific examples include fluororesins such as polyvinylidene fluoride (PVDF). In addition, for example, in the case where a sulfide-based solid electrolyte is contained in the positive electrode composition (described in detail later), the positive electrode composition does not need to contain a binder if good formability can be ensured in forming the positive electrode composition even without a binder.

When a binder is required in the positive electrode composition, the content thereof is preferably 15% by mass or less, and is preferably 0.5% by mass or more. On the other hand, in the case where formability can be obtained in the positive electrode composition without the need for a binder, the content is preferably 0.5 mass % or less, more preferably 0.3 mass % or less, and even more preferably 0 mass % (i.e., no binder is contained).

It is preferable that the positive electrode composition can contain a solid electrolyte.

The solid electrolyte to be included in the positive electrode composition is not particularly limited as long as it has lithium ion conductivity, and the examples thereof can include sulfide-based solid electrolytes, hydride-based solid electrolytes, halide-based solid electrolytes, and oxide-based solid electrolytes.

The examples as sulfide-based solid electrolytes to be used can include particles such as Li₂S—P₂S₅, Li₂S—SiS₂, Li₂S—P₂S₅—GeS₂, and Li₂S—B₂S₃ glass can be mentioned. In addition, because of high Li-ion conductivity, an attention in recent years has been focused at one in the thio-LISICON type [Li_{12-12a-b+c+6d-e}M¹_{3+a-b-c-d}M²_{b}M³_{c}M⁴_{d}M⁵₁₂₋ₑXₑ (where M¹ is Si, Ge or Sn, M² is P or V, M³ is Al, Ga, Y or Sb, M⁴ is Zn, Ca or Ba, M⁵ is either S or O, and X is F, Cl, Br or I, with 0≤a<3, 0≤b+c+d≤3, 0≤e≤3) (e.g., Li₁₀GeP₂S₁₂, Li_{9.54}Si_{1.74}P_{1.44}S_{11.7}Cl_{0.3}, etc.)], and one having an argyrodite-type crystal structure.

Examples of a hydride-based solid electrolytes include LiBH₄, solid solutions of LiBH₄ and the following alkali metal compounds (for example, those in which the molar ratio of LiBH₄ to the alkali metal compound is 1:1 to 20:1), and the like. The example of the alkali metal compound in the solid solutions can include at least one selected from the group consisting of lithium halides (such as LiI, LiBr, LiF, and LiCl), rubidium halides (such as RbI, RbBr, RbF, and RbCl), cesium halides (such as CsI, CsBr, CsF, and CsCl), lithium amide, rubidium amide, and cesium amide.

The examples of halide-based solid electrolytes can include monoclinic LiAlCl₄, defective spinel or layered structure LiInBr₄, and monoclinic Li₆₋₃ₘYₘX₆ (where 0<m<2 and X═Cl or Br), and other known solid electrolytes that can be used include those described in, for example, WO 2020/070958 and WO 2020/070955.

The examples of oxide-based solid electrolytes can include garnet-type Li₇La₃Zr₂O₁₂, NASICON-type Li_{1+O}Al_{1+O}Ti_{2-O}(PO₄)₃, Li₁₊ₚAl₁₊ₚGe₂₋ₚ(PO₄)₃, and perovskite-type Li_{3q}La_{2/3-q}TiO₃.

Among these solid electrolytes, a sulfide-based solid electrolyte is preferable because of its high lithium ion conductivity; a sulfide-based solid electrolyte containing Li and P is more preferable; and a sulfide-based solid electrolyte having an argyrodite-type crystal structure is further preferable because it has higher lithium ion conductivity and is chemically stable.

As a sulfide-based solid electrolyte having an argyrodite-type crystal structure, particularly preferable example is, for example, Li₆PS₅Cl or the like, and they are represented by the following general composition formula (1), the following general composition formula (2), or the following general composition formula (3).

Li₇₋ₖPS₆₋ₖXₖ (1)

In the general composition formula (1), X represents one or more halogen elements, and is 0.2<k<2.0 or 0.2<k<1.8.

Li_{7-x-y}PS₆₋ₓCl_{x+y} (2)

In the general formula (2) mentioned above, 0.05≤y≤0.9, −3.0x+1.8≤y≤−3.0x+5.7.

Li₇₋ₐPS₆₋ₐCl_{b}Br_{c} (3)

In the general composition formula (3), a=b+c, 0<a≤1.8, 0.1≤b/c≤10.0.

From the viewpoint of reducing grain boundary resistance, the average particle size of the solid electrolyte is preferably 0.1 μm or more, and more preferably 0.2 μm or more, while from the viewpoint of forming a sufficient contact interface between the active material and the solid electrolyte, the average particle size is preferably 10 μm or less, and more preferably 5 μm or less.

From the viewpoint of further increasing the ionic conductivity in the positive electrode to further improve the output characteristics of the flexible battery, the content of the solid electrolyte in the positive electrode composition is preferably 10 parts by mass or more, and more preferably 15 parts by mass or more, when the content of the positive electrode active material is 100 parts by mass. However, if the amount of the solid electrolyte in the positive electrode composition is too large, the amount of the other components may have to be reduced and the effect of them can be reduced. Therefore, the content of the solid electrolyte in the positive electrode composition is preferably 65 parts by mass or less, and more preferably 60 parts by mass or less, when the content of the positive electrode active material is 100 parts by mass.

Conductive substrate in a form of a sheet in the positive electrode can be of a porous metal substrate and a carbon sheet. As such a porous metal substrate, it is preferable to use a foamed metal porous body. The example of a foamed metal porous body can include ‘CELMET (registered trademark)’ manufactured by Sumitomo Electric Industries, Ltd. In addition, such a porous metal substrate usually has a thickness before being used on the positive electrode (power generation element) is usually larger than the thickness mentioned above (thickness in the positive electrode) (for example, the thickness before compression is preferably 0.1 mm or more, more preferably 0.3 mm or more, particularly preferably 0.5 mm or more, while it is preferably 3 mm or less, and more preferably 2 mm or less, and particularly preferably 1.5 mm or less.). At the time of manufacturing the power generation element described later, it is compressed in the thickness direction, and the thickness becomes the value as described later.

In order to make it easier for the positive electrode composition to be filled in the vacancies of the porous metal substrate in the process of pressurizing the porous metal substrate and the positive electrode composition so as to easily integrate the porous metal substrate with the positive electrode composition layer, the porosity of the porous metal substrate before compression is preferably 80% or more, more preferably 90% or more, and particularly preferably 95% or more. On the other hand, in order to increase the conductivity by increasing the amount of the substrate above a certain amount, the porosity is preferably 99.5% or less, more preferably 99% or less, and particularly preferably 98.5% or less.

From the perspective of more reliably integrating the porous metal substrate with the positive electrode composition layer in the positive electrode, the thickness of the portion embedded in the positive electrode composition layer of the porous metal substrate is preferably 10% or more, and more preferably 20% or more of the thickness of the porous metal substrate (which includes the thickness of the entire porous metal substrate in which the positive electrode composition layer coexists. This same applies hereinafter unless otherwise specified).

In addition, in the positive electrode, in order to reduce the resistance when contacting a current collector for connecting positive electrodes of multiple power generation elements, it is desirable that the end of the porous metal substrate at the side opposite to the positive electrode composition layer is not embedded in the positive electrode composition layer, and therefore that the end of the positive electrode (the surface of the positive electrode) is composed only of the porous metal substrate. In other words, during the manufacturing of the power generation element described later, when the porous metal substrate is compressed in the thickness direction, it is desirable that the vacancies at the ends of the porous metal substrate are crushed and disappear, leaving only the porous metal substrate exposed at the surface of the positive electrode. However, it is acceptable if some of the vacancies at the ends of the porous metal substrate are not crushed and are filled with the positive electrode composition, as long as it does not significantly affect the contact resistance with the current collector, and a portion of the positive electrode active material can be exposed at the surface of the positive electrode along with the ends of the porous metal substrate.

FIG. 5, It is an image of a scanning electron microscope (SEM) of the surface in an example of the positive electrode. On the surface of the positive electrode shown in FIG. 5, the end of the porous metal substrate 122 is exposed, but a part of the positive electrode composition 121a is also exposed on the surface of the positive electrode by entering the vacancy present at the end of the porous metal substrate.

However, the larger the ratio (area ratio) of the positive electrode composition exposed on the surface of the positive electrode, the greater the contact resistance between the porous metal substrate and the current collector for connecting the positive electrodes of the multiple power generation elements. Therefore, it is desirable that the ratio of the area of the exposed positive electrode composition on the positive electrode surface is 50% or less, more preferably 25% or less, further preferably 15% or less, and particularly preferably 10% or less, in a planar view.

From the viewpoint of more reliably integrating the porous metal substrate with the positive electrode composition layer in the positive electrode when at least a part of the porous metal substrate is embedded in the surface part of the positive electrode composition layer, the thickness of the porous metal substrate is preferably 1% or more, more preferably 2% or more, and particularly preferably 3% or more, of the overall thickness of the positive electrode composition layer (which includes the thickness of the portion coexisting with the porous metal substrate; unless otherwise specified, the term “thickness of the positive electrode composition layer” as described below means “the overall thickness of the positive electrode composition layer”). Further, from the viewpoint of enhancing the fillability of the positive electrode composition layer in the positive electrode, the thickness of the porous metal substrate is preferably 30% or less of the thickness of the positive electrode composition layer, more preferably 20% or less thereof, and particularly preferably 10% or less thereof.

In the positive electrode, the thickness of the porous metal substrate is preferably 10 μm or more, more preferably 20 μm or more, and particularly preferably 30 μm or more, while it is preferably 300 μm or less, more preferably 200 μm or less, and particularly preferably 100 μm or less. Further, the thickness of the positive electrode composition layer is preferably 0.2 mm or more, more preferably 0.4 mm or more, particularly preferably 0.6 mm or more, while it is preferably 2 mm or less, more preferably 1.7 mm or less, and particularly preferably 1.5 mm or less.

The thickness of the porous metal substrate, the thickness of the positive electrode composition layer, and the thickness of the negative electrode composition layer referred to in this specification can be determined by a SEM image at a magnification of 50 to 1000 times at a cross-section in the thickness direction of the positive electrode or the negative electrode to obtain a maximum width in the thickness direction of the areas where the porous metal substrate is confirmed to exist and the areas where the positive electrode composition or the negative electrode composition is confirmed to exist. Further, the thickness of the portion of the porous metal substrate embedded in the positive electrode composition layer or the negative electrode composition layer is determined by the maximum value of the width in the thickness direction of the portion where the region in which the porous metal substrate can be confirmed to exist and the area in which the positive electrode composition can be confirmed to exist or the area where the negative electrode composition can be confirmed to exist. (Each value in the Examples described later was obtained by these methods.)

Further, the proportion (area ratio) of the positive electrode composition exposed on the surface of the positive electrode and the proportion (area ratio) of the negative electrode composition exposed on the surface of the negative electrode can be determined by a SEM image at a magnification of 50 to 200 times to obtain a ratio (A/B), in which A is the sum of the areas of the exposed position electrode composition or the exposed negative electrode composition, and B is the area of the entire positive electrode or the entire negative electrode. (Each value in the Examples described later was obtained by this method.)

### Negative Electrode

The negative electrode has a negative electrode composition layer containing a negative electrode active material, etc. and a sheet-like porous metal substrate that functions as a current collector.

The examples of the negative electrode active material can include a carbon material such as graphite, a lithium titanium oxide (such as lithium titanate), a simple substance comprising an element such as Si and Sn, a compound (such as an oxide), and an alloy thereof. Further, lithium metal and lithium alloys (lithium-aluminum alloys, lithium-indium alloys, etc.) can also be used as a negative electrode active material.

The content of the negative electrode active material in the negative electrode composition is preferably 40 to 80% by mass from the viewpoint of increasing the energy density of the battery.

The negative electrode composition can contain a conductive assistant. Specific examples thereof can include the same conductive assistants as those exemplified above as those that can be contained in the positive electrode composition. The content of the conductive assistant in the negative electrode composition is preferably 10 to 30 parts by mass when the content of the negative electrode active material is 100 parts by mass.

The negative electrode composition can contain a binder. Specific examples include the same binders as those exemplified above as those that can be contained in the positive electrode composition. In addition, for example, in the case where a sulfide-based solid electrolyte is contained in the negative electrode composition (described later), the negative electrode composition does not need to contain a binder if good formability can be ensured in forming the negative electrode composition even without a binder.

When a binder is required in the negative electrode composition, the content thereof is preferably 15% by mass or less, and is preferably 0.5% by mass or more. On the other hand, in the negative electrode composition, when formability can be obtained without requiring a binder, the content is preferably 0.5% by mass or less, more preferably 0.3% by mass or less, and yet more preferably 0% by mass (that is, the binder is not contained).

It is preferable that the negative electrode composition can contain a solid electrolyte. Specific examples thereof include the same solid electrolytes as those exemplified above as those that can be contained in the positive electrode composition. Among the solid electrolytes of the above-described examples, since the lithium ion conductivity is high and has a function of enhancing the formability of the negative electrode composition, it is preferable to use a sulfide-based solid electrolyte, and it is more preferable to use a sulfide-based solid electrolyte having an argyrodite-type crystal structure, and it is yet more preferable to use one represented by the general composition formula (1), the general composition formula (2) or the general composition formula (3).

For the same reasons as for the positive electrode composition, the average particle diameter of the solid electrolyte related to the negative electrode composition is preferably 0.1 μm or more, more preferably 0.2 μm or more, and preferably 10 μm or less, and more preferably 5 μm or less.

From the perspective of further enhancing ion conductivity within the negative electrode to improve the output characteristics of the flexible battery, the content of the solid electrolyte in the negative electrode composition is preferably 30 parts by mass or more, and more preferably 35 parts by mass or more, when the content of the negative electrode active material is 100 parts by mass. However, if the amount of the solid electrolyte in the negative electrode composition is too large, the amount of the other components may have to be reduced and the effect of them can be reduced. Therefore, the content of the solid electrolyte in the negative electrode composition is preferably 130 parts by mass or less, and more preferably 110 parts by mass or less, when the content of the negative electrode active material is 100 parts by mass.

The conductive substrate in a form of a sheet in the negative electrode can be of a porous metal substrate, a carbon sheet, or the like in the same manner as the positive electrode. As such a porous metal substrate, it is preferable to use a foamed metal porous body. The example of a foamed metal porous body can include ‘CELMET (registered trademark)’ manufactured by Sumitomo Electric Industries, Ltd. In addition, such a porous metal substrate usually has a thickness before being used on the negative electrode (power generation element) is usually larger than the thickness mentioned above (thickness in the negative electrode) (for example, the thickness before compression is preferably 0.1 mm or more, more preferably 0.3 mm or more, particularly preferably 0.5 mm or more, while it is preferably 3 mm or less, and more preferably 2 mm or less, and particularly preferably 1.5 mm or less.). At the time of manufacturing the power generation element described later, it is compressed in the thickness direction, and the thickness becomes the value as described later.

In order to make it easier for the negative electrode composition to be filled in the vacancies of the porous metal substrate in the process of pressurizing the porous metal substrate and the negative electrode composition so as to easily integrate the porous metal substrate with the negative electrode composition layer, the porosity of the porous metal substrate before compression is preferably 80% or more, more preferably 90% or more, and particularly preferably 95% or more. On the other hand, in order to increase the conductivity by increasing the amount of the substrate above a certain amount, the porosity is preferably 99.5% or less, more preferably 99% or less, and particularly preferably 98.5% or less.

From the perspective of more reliably integrating the porous metal substrate with the negative electrode composition layer in the negative electrode, the thickness of the portion embedded in the negative electrode composition layer of the porous metal substrate in the negative electrode is preferably 10% or more, and more preferably 20% or more of the thickness of the porous metal substrate (which includes the thickness of the entire porous metal substrate in which the negative electrode composition layer coexists. This same applies hereinafter unless otherwise specified).

In addition, in the negative electrode, in order to reduce the resistance when contacting a current collector for connecting multiple negative electrodes of power generation elements, it is desirable that the end of the porous metal substrate at the side opposite to the negative electrode composition layer is not embedded in the negative electrode composition layer, and therefore that the end of the negative electrode (the surface of the negative electrode) is composed only of the porous metal substrate. In other words, during the manufacturing of the power generation element described later, when the porous metal substrate is compressed in the thickness direction, it is desirable that the vacancies at the ends of the porous metal substrate are crushed and disappear, thereby leaving only the porous metal substrate exposed at the surface of the negative electrode. However, it is acceptable that some of the vacancies at the ends of the porous metal substrate are not crushed and are filled with the negative electrode composition, as long as it does not significantly affect the contact resistance with the current collector, and that a portion of the negative electrode active material can be exposed at the surface of the negative electrode along with the ends of the porous metal substrate.

However, the larger the ratio (area ratio) of the negative electrode composition exposed on the surface of the negative electrode, the greater the contact resistance between the porous metal substrate and the current collector for connecting the negative electrodes of the multiple power generation elements. Therefore, it is desirable that the ratio of the area of the exposed negative electrode composition on the negative electrode surface is 50% or less, more preferably 25% or less, further preferably 15% or less, and particularly preferably 10% or less, in a planar view.

From the viewpoint of more reliably integrating the porous metal substrate with the negative electrode composition layer in the negative electrode when at least a part of the porous metal substrate is embedded in the surface part of the negative electrode composition layer, the thickness of the porous metal substrates preferably 1% or more, more preferably 2% or more, and particularly preferably 3% or more, of the overall thickness of the negative electrode composition layer (which includes the thickness of the portion coexisting with the porous metal substrate; unless otherwise specified, the term “thickness of the negative electrode composition layer” as described below means “the overall thickness of the negative electrode composition layer”). Further, from the viewpoint of enhancing the fillability of the negative electrode composition layer in the negative electrode, the thickness of the porous metal substrate is preferably 30% or less, more preferably 20% or less thereof, and particularly preferably 10% or less, of the thickness of the negative electrode composition layer.

In the negative electrode, the thickness of the porous metal substrate is preferably 10 μm or more, more preferably 20 μm or more, and particularly preferably 30 μm or more, while it is preferably 300 μm or less, more preferably 200 μm or less, and particularly preferably 100 μm or less. Furthermore, the thickness of the negative electrode composition layer is preferably 0.2 mm or more, more preferably 0.5 mm or more, and particularly preferably 0.7 mm or more, while it is preferably 2 mm or less, more preferably 1.7 mm or less, and particularly preferably 1.5 mm or less.

### Solid Electrolyte Layer

In the power generation element, a solid electrolyte layer is interposed between the positive and negative electrodes. The examples of the solid electrolytes that can constitute the solid electrolyte layer can include those previously exemplified solid electrolytes that can be contained in the positive electrode composition. Among the solid electrolytes of the above-described examples, since the lithium ion conductivity is high and has a function of enhancing the formability, it is preferable to use a sulfide-based solid electrolyte, and it is more preferable to use a sulfide-based solid electrolyte having an argyrodite-type crystal structure, and it is yet more preferable to use one represented by the general composition formula (1), the general composition formula (2) or the general composition formula (3).

The solid electrolyte layer can be provided with a porous body such as a resin nonwoven fabric as a support.

The thickness of the solid electrolyte layer is preferably between 10 and 200 μm.

### Shape of the Power Generation Element, Etc.

There are no specific restrictions on the shape of the power generation element in a planar view; it can be circular, elliptical, or any polygon such as square, or hexagonal, but it is usually circular or square.

The power generation element can be composed solely of a unit laminated electrode body consisting of one positive electrode and one negative electrode laminated through a solid electrolyte layer, or it can be constructed by laminating several of the unit laminated electrode bodies (such as two, three, four, etc.). There are no particular restrictions on the number of the unit laminated electrode bodies provided in the power generation element, and it can be 10, 20, or more (usually up to about 15). In the case of a power generation element formed by laminating multiple unit laminated electrode bodies, the positive electrodes of the unit laminated electrode bodies can be electrically connected to each other by leads, and the negative electrodes of the unit laminated electrode bodies can also be electrically connected to each other by leads, thereby allowing for parallel connection of the unit laminated electrode bodies. Also, adjacent unit laminated electrode bodies can be stacked so that electrodes of opposite polarities face each other, using a conductive metal foil or the like as a collector, thereby allowing for series connection. Furthermore, in the case of a power generation element formed by laminating multiple unit laminated electrode bodies, the outermost electrodes of the power generation element are configured such that one is a positive electrode and the other is a negative electrode.

### Method for Manufacturing the Power Generation Element

The power generation element can be manufactured by a method that includes, for example, the following first to third steps.

In the first step, the electrode composition (i.e., positive electrode composition or negative electrode composition) is placed into a mold and subjected to pressure molding. The surface pressure during the pressure molding in the first step is preferably from 30 to 500 MPa.

Next in the second step, a conductive substrate in a form of a sheet is placed on the electrode composition that was pressure-formed in the first step, followed by the subsequent third step in which the electrode composition and the conductive substrate are pressed together to form the electrode (positive electrode or negative electrode). At this time, when a sheet-like porous metal substrate is used as the conductive substrate, through the pressing in the third step, the porous metal substrate at its end at the side of the electrode composition is embedded from into the electrode composition and the electrode composition is further compressed, while the porous metal substrate is compressed in the thickness direction, thereby forming an electrode (positive or negative) that integrates the electrode composition layer (positive composition layer or negative composition layer) with the porous metal substrate.

As mentioned above, when using a porous metal substrate as a conductive substrate in a form of a sheet, in the third step, the porous metal substrate is compressed in the thickness direction. In terms of ensuring a more reliable connection between the porous metal substrate and the electrode composition layer, it is preferable for the thickness of the porous metal substrate after compression to be 30% or less, more preferably 20% or less, and particularly preferably 10% or less, of the thickness before compression. Additionally, in order to enhance the bonding strength between the porous metal substrate and the electrode composition layer by retaining a certain amount of electrode composition within the pores of the porous metal substrate, it is preferable for the thickness of the porous metal substrate after compression in the third step to be 1% or more, and more preferably 2% or more, of the thickness before compression.

In order to sufficiently increase the density of the electrode composition layer formed by compression molding of the electrode composition, the surface pressure during pressing in the third step is preferably above 800 MPa more, more preferably above 1,000 MPa, and particularly preferably above 1,200 MPa. There is no specific upper limit for the surface pressure during pressing in the third step, but in general pressing equipment, the upper limit is usually around 2,000 MPa.

When using a porous metal substrate as a conductive substrate in a form of a sheet, by going through the first to the third steps, an electrode (positive or negative) can be formed in such a configuration that at least a part the porous metal substrate at its end at the side of the electrode composition layer (a certain range in the thickness direction from the end of the porous metal substrate) is embedded in the electrode composition layer and integrated with it, and that the other end of the porous metal substrate is exposed on the surface of the electrode.

In addition, if the surface pressure during the pressurization in the third step becomes high, there is a possibility that cracks may occur when the porous metal substrate is compressed. However, even in cases where it is cut to produce fragments but the ends are still exposed on the surface of the electrode, it can contribute to reducing contact resistance.

The aforementioned first, second, and third steps are carried out to produce the positive electrode and the negative electrode, which are disposed on both sides of a solid electrolyte layer, respectively, and pressing them if necessary, thereby forming the power generation element.

Furthermore, before the first step, a preliminary step can be added to put the solid electrolyte into a mold to apply pressure forming. Onto the solid electrolyte thus pressure-formed in this preliminary step, an electrode composition (positive electrode composition or negative electrode composition) is placed, and then the first, second, and third steps are carried out sequentially, thereby producing an integrated body of the solid electrolyte layer and the electrode (positive electrode or negative electrode) to be used as a power generation element.

The surface pressure during the press molding in the preliminary step is preferably set from 30 to 120 MPa.

Additionally, it is also possible to manufacture a power generation element by first forming one of the electrodes, that is, either the positive or negative electrode, on one side of a solid electrolyte layer by performing the preliminary, first, second, and third steps, and then forming the other electrode (negative or positive) on the other side of the solid electrolyte layer by performing the first, second, and third steps.

### Arrangement and Number of Power Generation Elements

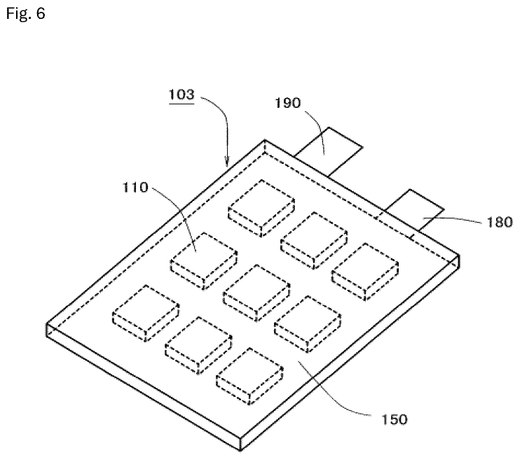

FIG. 6 shows a perspective view schematically illustrating an example of a flexible battery. In FIG. 6, to explain the arrangement of the power generation elements 110 inside the flexible battery 103, each power generation element 110 and the lower side of the substrate that make up the exterior body 150 and a part of connection terminal 190 are indicated by dotted lines. In the flexible battery 103 shown in FIG. 6, nine power generation elements 110 are arranged in three vertical rows and three horizontal rows inside the exterior body 150.

In the flexible battery, according to the shape in a plain of the exterior body, multiple power generation elements can be arranged in a single row in a linear fashion as shown in FIG. 6. Alternatively, they can be arranged in multiple rows vertically and horizontally, or in a circular shape, or in multiple rows in concentric circles.

There are no specific restrictions on the number of power generation elements to be placed inside a flexible battery, as long as there are multiple, that is, two or more, and they can be selected as appropriate according to the characteristics required when the battery is applied. For example, the number of power generation elements can be 10, 100, 1,000, or more.

### Flexible Substrate, Current Collector and Exterior Body

In this specification, “flexibility” in the term “flexible substrate” means the ability to bend 180 degrees when folded around a core with an outer diameter of 3 mm.

The examples of flexible substrates for arranging power generation elements can include flexible sheet materials (such as films with essentially no vacancies, woven fabrics, and non-woven fabrics).

Materials used as substrates include resins such as nylon (like nylon 66), polyester (such as polyethylene terephthalate (PET)), polyolefins (polypropylene, polyethylene, and etc.), polyurethane, epoxy, and polyimide. In addition, the metal foil (plate), which is described later as an example of a current collector for connecting the positive electrodes or the negative electrodes of a power generating element, can be used as a flexible substrate (a metallic flexible substrate).

The thickness of the substrate is preferably between 1 and 100 μm.

The current collector that connects the positive electrodes of multiple power generation elements or the negative electrodes can be of a metal foil (a plate), a wire, etc., made of stainless steel, nickel, aluminum, iron, copper, clad materials combining these, or these materials with a plating of nickel, chromium, or nickel-chromium. From the perspective of suppressing the degradation of battery characteristics due to deterioration of the electrical connections between the positive electrodes of multiple power generating elements or between the negative electrodes of multiple power generating elements, resulting from e.g., damage to the current collectors when the flexible battery is deformed, it is preferable that the current collector is made of a metal foil (a plate).

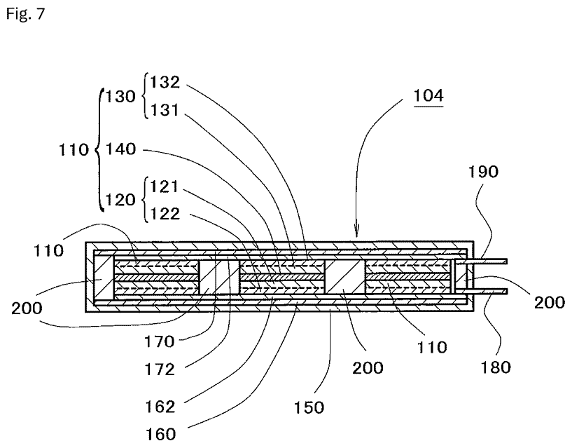

The current collector can be integrally formed with the flexible substrate or or individually formed on or above the flexible substrate. When the current collector is integrally formed, for example, it can be prepared by lamination or spattering on the flexible substrate. When the current collector is individually formed, for example, it can be prepared by stacking it on the flexible substrate. Additional layer(s) such as an insulating layer explained later can be intervened between the current collector and the flexible substrate. FIG. 7 shows a cross-section of an embodiment of a flexible battery 104 including flexible substrates 160, 170, and the current collector 162, 172 made of a metal wire which are separately provided from the flexible substrates 160, 170. The thickness of the current collector made of a metal foil (a plate) or a metal wire is preferably 1 to 100 μm.

In addition, a flexible battery can use a flexible substrate that has an insulating layer and a conductive layer, and the conductive layer can function as a current collector for connecting the positive electrodes and the negative electrodes, respectively, of multiple power generation elements.

As an insulating layer in the substrate having an insulating layer and a conductive layer, a flexible sheet material having the aforementioned can be used.

In addition, as a conductive layer in the substrate having an insulating layer and a conductive layer, a metal foil that can be used for the current collector can be used. The thickness of the conductive layer is preferably between 1 and 100 μm.

In the substrate having an insulating layer and a conductive layer, it is preferable that the thickness of the insulating layer is set to satisfy the above-mentioned preferred thickness of the conductive layer and to satisfy the above-mentioned preferred thickness of the overall thickness of the substrate.

The exterior body of the flexible battery should be flexible when used as a battery. For example, the examples thereof can include those made of a resin film or those made of a laminated film with a metal layer on the surface of the resin film. The resin film for constituting the exterior body that can be used can be the same type of sheet-like resin materials used as a flexible substrate, but which film has substantially no vacancies. Additionally, the laminated film for constituting the exterior body can be of the same type of material having an insulating layer and a conductive layer that can be used as a flexible substrate.

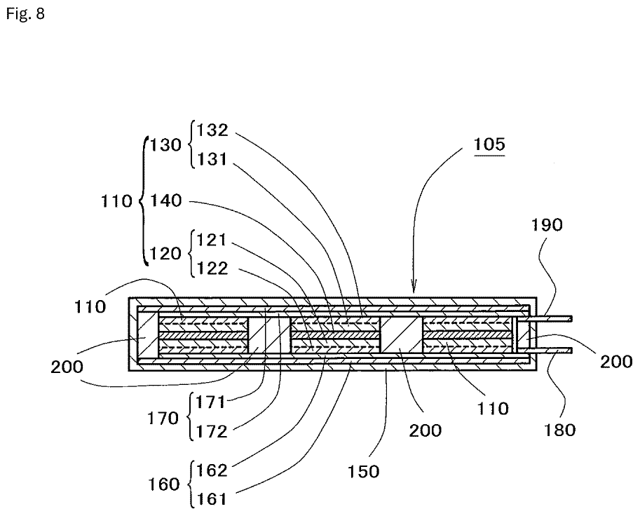

FIG. 8 is a cross-sectional view showing an example of a flexible battery 105 in which multiple power generating elements are arranged on a flexible substrate 160 having an insulating layer 161 and a conductive layer (current collector) 162, and a flexible substrate 170 having an insulating layer 171 and a conductive layer (current collector) 172, and housed within an exterior body 150.

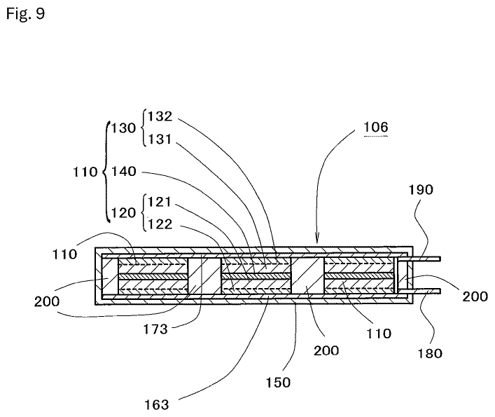

FIG. 9 is a cross-sectional view showing an example of a flexible battery 106 in which multiple power generating elements 110 are arranged on the metallic flexible substrates 163, 173 such as metal foil, the positive electrodes 120 of these power generating elements are connected to each other via the flexible substrate 163, and the negative electrodes 130 are connected to each other via the flexible substrate 173, and the battery is housed in an exterior body 150.

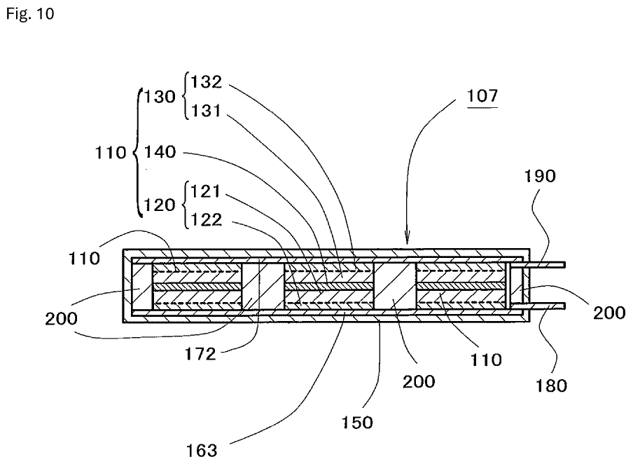

FIG. 10 shows an example of a flexible battery 107 in which multiple power generating elements 110 are arranged on a metallic flexible substrate 163, the positive electrodes 120 of these power generating elements are connected to each other via the flexible substrate 163, and the negative electrodes 130 are connected to each other via a current collector 172 made of a metal wire, and the battery is housed in an exterior body 150.

In the flexible battery shown in FIG. 10, a plurality of power generating elements can be arranged on the negative electrode side of the metallic flexible substrate, the negative electrodes can be connected to each other with the metallic flexible substrate, and the positive electrodes of the plurality of power generating elements can be connected to each other with a current collector made of a metal wire. As shown in FIGS. 7, 8, 9, and 10 described above, a plurality of power generating elements arranged on a flexible substrate can be housed in an exterior body made of a resin film or a laminate film to form a flexible battery.

Furthermore, as shown in FIGS. 1-4, the exterior body can be composed of a substrate that has a flexibility for arranging the power generation elements. That is, the exterior body can be formed by sealing the outer peripheral edges of two substrates that have arranged power generation elements together by adhesion or the like.

The adhesion between the substrates forming the exterior body can be carried out by thermally fusing them through materials such as ionomer resins. For example, ionomer resins such as “HIMILAN (ethylene-based ionomer resin, product name)” manufactured by DOW-MITSUI POLYCHEMICALS CO.,LTD. can be used.

There are no specific restrictions on the shape of the exterior body in a planar view, and it can be a polygon such as a square or a circular shape.

### Connection Terminal

The connection terminal for connecting the flexible battery to applicable devices can be established by a metal plate made of stainless steel, nickel, aluminum, iron, copper, clad materials combining these, or these materials with a plating of nickel, chrome, or nickel-chrome. The thickness of the connection terminal is preferably between 10 and 300 μm.

### Insulator

As an insulator placed in areas of a flexible substrate where power generation elements are not arranged, the examples thereof can include resins such as an ionomer resin (the same one as those previously exemplified for bonding substrates to form an exterior body), a polyolefin (such as polypropylene and polyethylene), a polyurethane, an epoxy, and a polyimide.

In addition, when using an insulator, the part where the insulator is placed should have the same flexibility as the substrate so that the battery can be flexible. The thickness of the insulator is preferably between 10 and 200 μm from the perspective of ensuring good flexibility and insulation.

### EXAMPLES

The present invention will be described in detail below with reference to the Examples. However, it is noted that the following examples should not be used to narrowly construe the scope of the present invention.

### Example 1

A negative electrode composition was prepared by mixing lithium titanate (Li₄Ti₅O₁₂, negative electrode active material) with an average particle diameter of 2 μm, a sulfide-based solid electrolyte (Li₆PS₅Cl) with an average particle diameter of 0.7 μm, and graphene (conductive assistant) in a mass ratio of 50:41:9.

In addition, a positive electrode composition was prepared by mixing LiCoO₂ which surface has formed a coating layer of LiNbO₃ (positive electrode active material) with an average particle diameter of 5 μm, a sulfide-based solid electrolyte (Li₆PS₅Cl) with an average particle diameter of 0.7 μm, and graphene in a mass ratio of 65:30.7:4.3.

Next, powders of sulfide-based solid electrolyte (Li₆PS₅Cl) with an average particle diameter of 0.7 μm was placed into a powder molding die, and press molding was performed at a surface pressure of 70 MPa to form a pre-molded layer of the solid electrolyte layer. Furthermore, the negative electrode composition was placed on the upper surface of the pre-molded layer of the solid electrolyte layer, and press molding was performed at a surface pressure of 50 MPa, thereby forming an additional pre-molded layer of the negative electrode on the top of the pre-molded layer of the solid electrolyte.

Next, a nickel-based foamed metal porous body (‘CELMET’, registered trademark, made of nickel) manufactured by Sumitomo Electric Industries, Ltd., was cut into a square of 10 mm×10 mm (thickness: 1.2 mm, porosity: 98%) and was placed on the pre-formed layer of the negative electrode formed on the pre-formed layer of the solid electrolyte layer, followed by applying pressure molding at a surface pressure of 300 MPa, thereby forming an integrated body of the solid electrolyte layer with the negative electrode.

Furthermore, after the molding die was turned upside down, the positive electrode composition was placed on the upper surface of the solid electrolyte layer in the molding die (i.e., the surface opposite to the surface having the negative electrode), and pressure molding was performed at a surface pressure of 50 MPa to form a pre-formed molded layer for the positive electrode on the solid electrolyte layer.

Next, a cut piece of a foamed metal porous body made of nickel, that is the same as that used for the negative electrode, was placed on the pre-formed molded layer of the positive electrode formed on the solid electrolyte layer, followed by performing pressure molding at a surface pressure of 1,400 MPa, thereby obtaining a power generating element having a shape of 10 mm×10 mm in planar view and a height of 1.4 mm.

In the power generating element thus obtained, the thickness of the negative electrode composition layer of the negative electrode was 740 μm, and the thickness of the porous metal substrate was 50 μm (4% of the thickness of the porous metal substrate before use in the negative electrode), the thickness of the portion of the porous metal substrate embedded in the negative electrode composition layer was 10 μm (20% of the total thickness of the porous metal substrate), respectively. In addition, the area ratio of the portion of the negative electrode composition exposed on the surface of the negative electrode was 7%.

In the power generating element thus obtained, the thickness of the positive electrode composition layer of the positive electrode was 420 μm, the thickness of the porous metal substrate was 50 μm (4% of the thickness of the porous metal substrate before use in the positive electrode), and the thickness of the portion of the porous metal substrate embedded in the positive electrode composition layer was 10 μm (20% of the total thickness of the porous metal substrate), respectively. In addition, the area ratio of the portion of the positive electrode composition exposed on the surface of the positive electrode was 7%.

Two laminate films measuring 60 mm×60 mm (insulating layer thickness: 45 μm, conductive layer thickness: 40 μm) having an insulating layer made of nylon 66 and a conductive layer made of stainless steel foil were prepared, and nickel connection terminals (3 mm×15 mm, thickness: 50 μm) were attached to each of them.

Then, nine power generating elements obtained as described above were arranged in 3 rows and 3 columns with a spacing of 10 mm between each power generating element on the conductive layer of one of the laminate films. An ionomer resin (HIMILAN (product name) manufactured by DOW-MITSUI POLYCHEMICALS CO.,LTD.) was placed with a thickness of 0.1 mm in the areas where no power generating elements were placed.

Then, the other laminate film was placed to cover the power generation elements with the conductive layer facing them. The entire structure was heat-pressed to fuse the ionomer resin with the upper and lower laminate films, and also the outer peripheral edges of the four sides were further sealed by heat pressing to obtain a flexible battery.

### REFERENCE EXAMPLE

On both surfaces at the sides of the positive electrode and the negative electrode of the power generation element prepared in the same manner as in Example 1, a 50 mm thick nickel lead was resistance welded. It was sandwiched by a three-layer laminate film of nylon/aluminum/CPP (non-oriented polypropylene) (each thickness was 25 μm/40 μm/40 μm thick) such that each lead protruded from the laminate film. As a result, an all-solid-state battery was prepared by sealing the four outer peripheral edges of the laminate film by heat pressing. A flexible battery was prepared in the same manner as in Example 1, except that these all-solid-state batteries were arranged in place of the power generation elements such that each lead was in contact with the conductive layer of the exterior body.

### Comparative Example 1

A flexible battery was prepared in the same manner as in Example 1, except that a nickel-foamed porous metal body was not placed on the surface of the positive and negative electrodes, and a power generating element with a height of 1.3 mm was used.

The flexible batteries of the Examples, the Reference Examples, and the Comparative Example were evaluated as follows.

### 0.2 C Discharge Capacity

Each of the flexible batteries of the Examples, the Reference Examples, and the Comparative Example, in an unfolded state, was charged at a constant current of 0.5 C until the voltage reached 2.6V, and then at a constant voltage of 2.6V until the current reached 0.01 C, assuming that 90 mA is equivalent to 1 C. After that, the battery was discharged at a constant current of 0.2 C until the voltage reached 1.0V. The discharge capacity at this time was taken as the 0.2 C discharge capacity of each flexible battery.

### 0.5 C Discharge Capacity

Each flexible battery whose 0.2 C discharge capacity had been measured was charged in the same manner as above, and then discharged at a constant current equivalent to 0.5 C until the voltage reached 1.0V. The discharge capacity at this time was taken as the 0.5 C discharge capacity of each flexible battery.

Next, each of the flexible batteries of the Examples, the Reference Examples, and the Comparative Example was folded twice in the vertical direction at a portion where the power generating elements were not disposed, to obtain the same state as shown in FIG. 4. Then, the 0.2 C discharge capacity and the 0.5 C discharge capacity were measured in the same manner as above. These were defined as the 0.2 C discharge capacity in the folded state and the 0.5 C discharge capacity in the folded state, respectively.

### Evaluation of Energy Density

The maximum volume of each of the flexible batteries of the Examples, the Reference Examples, and the Comparative Example was calculated by multiplying the maximum lengths of each side of each battery in a state where the battery was folded twice as described above. The energy density (volume energy density) of each flexible battery was calculated by multiplying the 0.2 C discharge capacity in the folded state by the average operating voltage during discharge to obtain a product, which was divided by the maximum volume calculated as described above.

The results of the discharge capacity for each of the flexible batteries of the Examples, the Reference Examples, and the Comparative Example are shown in Table 1. Each value in Table 1is a relative value when the 0.2 C discharge capacity obtained when the flexible battery of Example 1 was in an unfolded state is taken as 100.

TABLE 1

| | Unfolded state | | Folded state | |
|---|---|---|---|---|
| | 0.2 C | 0.5 C | 0.2 C | 0.5 C |
| | discharge | discharge | discharge | discharge |
| | capacity | capacity | capacity | capacity |
| Example 1 | 100 | 85 | 99 | 83 |
| Reference | 100 | 85 | 99 | 84 |
| Example | | | | |
| Comparative | 98 | 60 | 96 | 57 |
| Example 1 | | | | |

The energy density of each of the flexible batteries of the Examples, the Reference Examples, and the Comparative Example was calculated as shown in Table 2. Note that each value in Table 2 is a relative value when the value of the flexible battery of Example 1 is set to 100.

TABLE 2

| | maximum | |
|---|---|---|
| | volume | energy density |
| Example 1 | 100 | 100 |
| Reference | 113 | 88 |
| Example | | |
| Comparative | 94 | 102 |
| Example 1 | | |

As can be seen from Table 1, both the flexible batteries of Example 1 and the Reference Example were capable of charging and discharging when folded as shown in FIG. 4, just as they were when unfolded, and the capacity loss was less than 3%. For this reason, in the flexible battery of Example 1, each power generation element is not packaged, and the positive electrodes are directly connected to each other via a current collector, and the negative electrodes are directly connected to each other via a current collector. Despite the configuration, it can be said that the internal resistance was reduced to the same extent as in the flexible battery of the Reference Example in which each of the power generation elements is packaged and then connected to each other.

On the other hand, in the flexible battery of Comparative Example 1 in which each power generation element was not individually packaged and a conductive substrate in a form of a sheet (foamed metal porous body) was not arranged on the surface of the positive electrode composition layer and the negative electrode composition layer of each power generation element, the obtained discharge capacity was smaller, especially when the discharge current was high, compared to the flexible battery of Example 1. Therefore, it can be said that the flexible battery of Comparative Example 1 has an increased internal resistance compared to the flexible battery of Example 1.

Furthermore, as can be seen from Table 2, compared to the flexible battery of the Reference Example, in which the power generation elements were wrapped in an exterior body and arranged as an all-solid-state battery, Example 1, in which each power generation element was not packaged and in which the positive electrodes were directly connected to each other with a current collector and the negative electrodes were directly connected to each other with a current collector, was able to increase the energy density.

There can be provided other embodiments than the description above without departing the gist of the present invention. The embodiment described above is an example only, and the present invention is not limited to the specific embodiment. The scope of the present invention should be construed primarily based on the claims, not to the description of the specification or the present application. Any changes within the terms of the claims and the equivalence thereof should be construed as falling within the scope of the claims.

### INDUSTRIAL APPLICABILITY

The flexible battery of the present invention can be used for applications similar to those of conventionally known primary batteries and secondary batteries, but since it has a solid electrolyte instead of an organic electrolyte, it has excellent heat resistance and can be preferably used in applications where it is exposed to high temperatures.

### EXPLANATION OF THE REFERENCE

100, 101, 102, 103, 104, 105, 106, 107: Flexible Batteries
110: Power generation element;
120: Positive electrode;
121: Positive electrode composition layer;
121a: Positive electrode composition;
122: Sheet-like porous metal substrate (conductive substrate in a form of a sheet);
130: Negative electrode;
131: Negative electrode composition layer;
132: Sheet-like porous metal substrate (conductive substrate in a form of a sheet);
140: solid electrolyte layer;
150: Exterior body;
160, 170: Flexible substrate;
161, 171: Insulating layer;
162, 172: Conductive layer (current collector);
163, 173: Metallic Flexible substrate;
180, 190: connection terminals; and
200: Insulator

What is claimed is:

1: A flexible battery comprising multiple power generation elements sealed within an exterior body,
wherein each of the power generation elements comprises a positive electrode, a negative electrode, and a solid electrolyte layer arranged between the positive and negative electrodes;
wherein the positive electrode comprises a positive electrode composition layer and a first conductive substrate in a form of a sheet arranged on the surface of the positive electrode composition layer;
wherein the negative electrode comprises a negative electrode composition layer and a second conductive substrate in a form of a sheet arranged on the surface of the negative electrode composition layer;
wherein the multiple power generation elements are arranged on a flexible substrate, and each positive electrode is directly connected to a first current collector, thereby connecting the positive electrodes to each other via the first current collector, and each negative electrode is directly connected to a second current collector, thereby directly connecting the negative electrodes to each other via the second current collector; and
wherein the first current collector connecting the positive electrodes to each other is connected to first external connection terminals, and the second current collector connecting the negative electrodes to each other is connected to second external connection terminal.

2: The flexible battery according to claim 1,
wherein the first conductive substrate of the positive electrode is a porous metal substrate, and at least a part thereof including an end at a side of the positive electrode composition layer is embedded in a surface part of the positive electrode composition layer, thereby integrating with the positive electrode composition layer, while the other end of the porous metal substrate of the positive electrode is exposed on the surface of the positive electrode, and
wherein the second conductive substrate of the negative electrode is a porous metal substrate, and at least a part thereof including an end at a side the negative electrode composition layer is embedded in a surface part of the negative electrode composition layer, thereby integrating with the negative electrode composition layer, while the other end of the porous metal substrate of the negative electrode is exposed on the surface of the negative electrode.

3. The flexible battery according to claim 1,
wherein the flexible substrate comprises an insulating layer and conductive layers, and
wherein the conductive layers function as the first current collector and the second current collector.

4: The flexible battery according to claim 1, wherein the exterior body is composed of the flexible substrate.

5: The flexible battery according to claim 1, wherein an insulator is disposed in at least a part of a region of the flexible substrate where the power generation element is not disposed of.

6: A flexible battery comprising multiple power generation elements sealed within an exterior body,
wherein each of the power generation elements comprises a positive electrode, a negative electrode, and a solid electrolyte layer arranged between the positive and negative electrodes;
wherein the positive electrode comprises a positive electrode composition layer and a first conductive substrate in a form of a sheet arranged on the surface of the positive electrode composition layer;
wherein the negative electrode comprises a negative electrode composition layer and a second conductive substrate in a form of a sheet arranged on the surface of the negative electrode composition layer;
wherein the multiple power generation elements are arranged on a first metallic flexible substrate and/or a second metallic flexible substrate, and each positive electrode is directly connected to the first metallic flexible substrate or a first current collector, thereby connecting the positive electrodes to each other via the first metallic flexible substrate or the first current collector, and each negative electrode is directly connected to the second metallic flexible substrate or a second current collector, thereby directly connecting the negative electrodes to each other via the second metallic flexible substrate or the second current collector; and
wherein the first metallic flexible substrate or the first current collector connecting the positive electrodes to each other is connected to first external connection terminals, and the second metallic flexible substrate or the second current collector connecting the negative electrodes to each other is connected to second external connection terminal.
